(19) United States
(12) Patent Application Publication
(10) Pub. No.: US 2006/0246180 A1
(43) Pub. Date: Nov. 2, 2006

(54) Natural cheese fortification

(76) Inventors: Mostafa K. Galal, Springfield, MO (US); Alan R. Szczesny, Manitowoc, WI (US); Gary L. Kerrigan, Sheboygan, WI (US)

Correspondence Address: HOVEY WILLIAMS LLP, 2405 GRAND BLVD., SUITE 400, KANSAS CITY, MO, 64108, US

(21) Appl. No.: 11/116,038

(22) Filed: Apr. 27, 2005

(51) Int. Cl. A23L 1/30

(52) U.S. Cl. 426/74

(57) ABSTRACT

Improved natural cheese-making processes are provided which permit substantial nutritional supplementation of the natural cheeses. Conventional cheese-making techniques involving curd formation, curd/whey separation, curd cooking, brining, and packaging are modified by addition of a suitable fortificant normally containing a mixture of vitamins and minerals. Fortificant addition can be carried out prior to or during cooking, as a part of the brining step, and/or during final packaging. Fortificant(s) are preferably added as aqueous dispersions or solutions, which can be directly added to liquid ingredients or sprayed on the curd or final cheese.

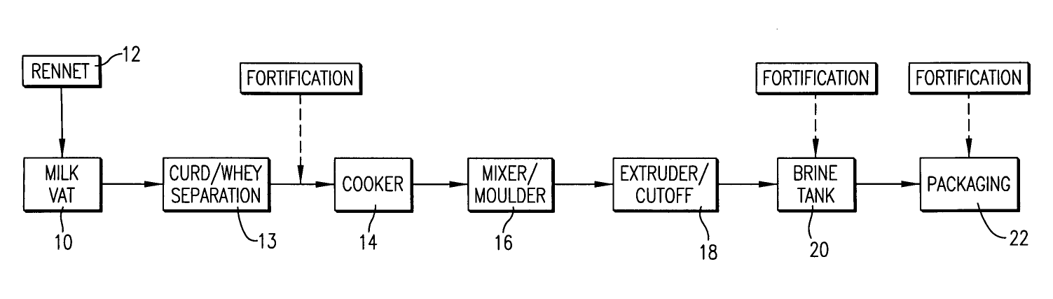

### BACKGROUND OF THE INVENTION

1. Field of the Invention

The present invention is broadly concerned with methods for fortification of natural cheese products with nutraceuticals such as vitamins and minerals to yield nutritionally enhanced, improved cheese products. More particularly, the invention is concerned with such methods wherein the natural cheese making process involving curd formation, curd cooking, brining, and packaging is modified by the addition of fortificant(s), typically as liquid dispersions, before or during the cooking step, during the brining step, and/or as a part of the packaging process.

2. Description of the Prior Art

Conventional processed cheese can readily be fortified by the addition of vitamins and minerals to the cheese formulas before processing. All added vitamins and minerals can be recovered in the finished processed cheese, save for any amounts that may be destroyed during the heating process. Indeed, such fortification of processed cheese has been carried out for many years.

Natural cheeses present a more difficult fortification problem. Specifically, in natural cheese-making, milk is coagulated by the action of acid and/or enzymes to form a curd/whey mixture, whereupon the whey is normally separated (however, some cheeses such as mozzarella can be produced without whey separation); thereupon the curd is commonly cooked, brined, and packaged. If fortificants are added at the outset of the natural cheese-making process, significant quantities thereof are lost during whey separation. As a consequence, it is heretofore not been economically feasible to fortify natural cheeses in the manner of processed cheeses.

U.S. Pat. No. 6,426,102 describes a process for the production of shredded cheese wherein natural cheese is shredded and a calcium-containing nutritional supplement is added and blended into the shredded cheese prior to packaging. This supplement was found to reduce or even eliminate the use of conventional anti-caking agents in such shredded cheese products. However, the '102 patent is limited to shredded cheeses and is not concerned with block or bulk-type natural cheeses such as relatively large pieces or extruded strings.

The prior art also describes a number of processes for the treatment of cheese products. U.S. Pat. No. 5,817,358 describes a method of salting cheese in the package to thereby eliminate the conventional brining step in cheese manufacture. The patent describes that the package-applied salt is absorbed in the cheese to achieve a salt equilibration.

U.S. Pat. No. 4,194,011 discloses a method of cheese manufacture wherein cheese precursor is packaged with addition of a lactic fermentation agent followed by incubation to form the cheese. Other ingredients such as fats and proteins may be added to the product.

U.S. Pat. No. 4,824,682 describes a process for in-package ripening of blue cheese. In the process, raw blue cheese curd is packaged and inoculated, followed by in-package ripening of the cheese.

UK Patent No. 1,557,982 describes a process for packing molten cheese by first melting cheese and pouring it into a liquid to form cheese agglomerates. The liquid is typically brine which may also contain flavorants.

European Patent Application 492,716 describes a process for treating cheese with a spray-on liquid using high pressure nozzles so that the liquid penetrates the cheese and diffuses therein. The sprayed on liquid is normally brine, but the application also discloses that the liquid can incorporate vitamins or other substances.

Similarly, French Patent No. 7609722 describes a brining process wherein heated cheese is quickly cooled and poured into containers partially filled with brine.

Netherlands Patent No. 8002991 teaches the packaging of processed cheese wherein the cheese is poured into a liquid and allowed to cool. The liquid contains olive oil.

U.S. Pat. No. 6,372,274 and related published application 2001/0046536 describe packaged meat or cheese products wherein the food has an added liquid (e.g., brine) which is injected into the food within a package.

Published Patent Application 2002/0106429 is somewhat similar to the above references and discloses packaged food products containing an added liquid. The reference is primarily directed to meat packaging, however.

### SUMMARY OF THE INVENTION

The present invention overcomes the problems outlined above and provides processes for natural cheese-making involving coagulation of milk to form curds, cooking the curd to form a natural cheese, brining the natural cheese, and then packaging the cheese. In particular, the invention involves adding a cheese fortificant during the process at a time selected from the group consisting of before or during the cooking step, during the brining step, and combinations thereof. In a more particular aspect of the invention, a natural cheese-making process for the production of extruded “string” cheese is provided wherein milk is coagulated to form a curd, the curd is cooked and then extruded to form elongated string pieces, and the latter are then brined and packaged. In such a string cheese process, fortificant may be added before or during the cooking step, during the brining step, prior to or during the packaging step, and any combinations thereof.

In more detail, the fortificant normally comprises at least one vitamin (and usually multiple vitamins) selecting from the group consisting of Vitamins A, B, B6, C, D, and E, and mixtures thereof. Moreover, the fortificant normally contains at least one mineral such as calcium, iron, zinc, and mixtures thereof. In order to facilitate addition of the fortificant, the ingredients thereof are preferably prepared as an aqueous dispersion or solution which can be sprayed onto the cheese using normal spraying equipment and spray pressures.

The processes of the invention are particularly suited for fortifying block or large piece cheeses, and especially string cheeses. Specifically, the cheeses can be in the form of consumer-sized blocks or pieces having a thickness or diameter of above about ⅜″, and especially from about ⅜″-1″. Essentially any type of natural cheese can be fortified in accordance with the invention, such as cheddar, Swiss, mozzarella, provolone, american, bleu, Gouda, Gorgonzola, ricotta, edam, farmner's, and feta and related cheeses.

The most preferred processes of the invention involve fortificant addition prior to the cooking process. In this way, the most even distribution of fortificant throughout the bulk of the natural cheese is achieved. At the same time, it has been found that many fortificant ingredients can survive the cooking process without undue degradation or losses. However, where possible the ingredients should be chosen for appropriate heat-resistence. When other fortificant addition routes are selected, it has been found that the fortificant will over time distribute throughout substantially the entirety of the bulk cheese.

Other conventional ingredients may be added during the course of the cheese-making process. For example, probiotics such as Acidophilus, B. Fidobacterium, Yogurt culture, and/or Lactobacilus may be added using conventional techniques.

### BRIEF DESCRIPTION OF THE DRAWING

The single FIGURE is a block diagram illustrating the steps of a typical natural cheese making process, and further depicting the points in the process where cheese fortification may occur in accordance with the invention.

### DETAILED DESCRIPTION OF THE PREFERRED EMBODIMENT

The FIGURE depicts a common process for the production of natural cheese, as well as cheese fortification during the course of the process. In particular, the cheese making process commences by introduction of starting milk into a milk vat 10. A conventional coagulant such as rennet from a source 12 may be added to the milk, and/or coagulating microorganisms. After a suitable time period, the milk is coagulated to create a mixture of curds and whey, with the latter being drawn off or separated as at 13. Thereupon, the retained curds are cooked in a cooker14 to a temperature on the order of 125-160° F. for a selected time, consistent with the type natural cheese being produced. In the case of string cheese, the cooked product is then passed to a mixture/molder 16 for stretching and forming, followed by passage to an extruder 18 equipped with a cutoff device. The output from the extruder is in the form of a cylindrical cheese string which is cut off to appropriate lengths. The cut product is then sent to a brine tank 20 for brining, usually for 5-10 minutes. The final step involves packaging the product in a packaging device 22.

Cheese fortification during this process may occur at three locations. The first fortification location would be after separation of the curds and whey, i.e., prior to or during the cooking operation. The fortificant may be in liquid or granular form. A second alternative would be to supplement the brine solution with fortificant, and here again the latter may be in liquid or solid form. A final option would be fortification prior to or during final packaging. In this case, the fortificant would almost always be in liquid form, and could be sprayed directly on the brined cheese or alternately into the packaging contemporaneous with the final packaging step. It will be appreciated that, if desired, the fortification of the cheese may occur at either one or multiple of the locations described.

It will be appreciated that the choice of where to add fortificant may depend upon the precise conditions of the overall cheese making process. Thus, if the cheese curd is subjected to relatively high time-temperature conditions during the cooking step, it may be advisable to fortify the product after cooking is completed. This is especially the case if the selected fortificant includes temperature-sensitive ingredients which may be wholly or partially inactivated at high temperatures.

The fortificants used in the invention may contain a wide variety of nutraceuticals, including minerals (e.g., calcium, potassium, zinc and/or iron), as well as vitamins such as vitamins A, C, D, E, and/or B6. Solutions or dispersions of such nutraceuticals are generally preferred, owing to ease of application and the ability to more readily disperse throughout the cheese.

The following examples set forth preferred natural cheese and fortification techniques in accordance with the invention. It is to be understood, however, that these examples are provided by way of illustration only, and nothing therein should be taken as a limitation upon the overall scope of the invention.

### EXAMPLE 1

In this example, a string cheese product was prepared with cheese fortification prior to the cooking step. Broadly speaking, the string cheese was prepared by first standardizing a quantity of milk in a milk vat, followed by adding rennet to produce a curd/whey mixture. The whey was then drained and the curd was salted. A selected vitamin and calcium blend fortificant was then added to the curd with mixing, and the curd was transferred to a cooker. The curd was cooked to a temperature of 140-145° F., whereupon the cooked curd was transferred to a mixer/molder for stretching and formation of cheese body. Thereupon, the product was passed through an extruder with a circular die plate to form a string, the latter being cut to single serving lengths weighing 21.3 g each. The string lengths were then brined in a brine solution for 5-10 minutes, followed by conventional packaging.

The fortificant used was made up of 93.62% by weight tricalcium phosphate, and 6.37% by weight of a commercially available DSM vitamin premix containing vitamins A, B6, C, D, E, and zinc. The fortificant was added at a level of 3.92% by weight, based upon the total weight of the fortified product taken as 100% by weight.

Laboratory testing of the final product confirmed the following retention rates for the fortificants: Vitamin A, 98.41%; Vitamin B6, −5.88%; Calcium, 109.19% (owing to the presence of Calcium in the starting milk); Vitamin C, 73.62%; Vitamin D, 0.0%; Vitamin E, 61.64%; and Zinc, 73.13%.

The product was subjected to a shelf-life evaluation study by storage over a period of six months at a temperature of 37° F. At the end of the storage period, the product was rated acceptable in color, appearance, taste, and texture.

### EXAMPLE 2

In this example, a string cheese product was prepared with cheese fortification at the brining step. The cheese processing method of Example 1 was carried out, without cheese fortification prior to cooking. At the brining step, a brine solution containing known levels of vitamins and zinc was prepared (tricalcium phosphate could not be dissolved in the liquid brine), and extruded single serving products were soaked in the brine solution for a period of 1, 2, and 3 hours. The 1-hour soaked products exhibited the following retention rates: Vitamin A, 34.61%; Vitamin B6, −7.38%; Calcium, 0.55%; Vitamin C, 109.70%; Vitamin D, 0.00%; Vitamin E, 42.61%; and Zinc, 149.47%. The 2-hour soaked product exhibited the following retention rates: Vitamin A, 34.61%; Vitamin B6, −7.38%; Calcium, −0.39%; Vitamin C, 212.49%; Vitamin D, 0.00%; Vitamin E, 39.99%; and Zinc, 152.09%. The 3-hour soaked product exhibited the following retention rates: Vitamin A, 23.60%; Vitamin B6, −7.38%; Calcium, 2.28%; Vitamin C, 251.38%; Vitamin D, 0.00%; Vitamin E, 44.58%; and Zinc, 186.18%.

### EXAMPLE 3

In this example, a string cheese product was prepared by the process described in Example 1, without addition of fortificants prior to cooking; rather, a vitamin slurry of known concentration was manually sprayed onto approximately 50 string cheese pieces as they entered packages (Calcium could not be sprayed by this technique). The following are the retention rates determined for this method: Vitamin A, 95.97%; Vitamin B6, 96.38%; Calcium, 7.0%; Vitamin C, 56.64%; Vitamin D, 60.89%; Vitamin E, 53.10%; and Zinc, 23.50%.

I/we claim:

1. In a natural cheese-making process comprising the steps of coagulating milk to form curd, cooking the curd to form natural cheese, brining the cheese, and packaging the cheese, the improvement which comprises the step of adding a cheese fortificant during said process at a time selected from the group consisting of before or during said cooking step, during said brining step, and combinations thereof.

2. The process of claim 1, including the step of adding said fortificant before said cooking step.

3. The process of claim 1, said fortificant comprising at least one vitamin.

4. The process of claim 3, said fortificant comprising vitamins selected from the group consisting of Vitamins A, B, B6, C, D, and E, and mixtures thereof.

5. The process of claim 3, said fortificant comprising at least one mineral.

6. The process of claim 5, said mineral selected from the group consisting of copper, iron, zinc, and mixtures thereof.

7. The process of claim 1, said natural cheese being a string cheese, said process including the step of extruding said natural cheese prior to said brining step in order to form elongated string pieces of said cheese.

8. The process of claim 7, said string cheese having a diameter of from about ⅜″-1″.

9. The process of claim 1, including the step of adding a probiotic during the cheese-making process.

10. In a natural cheese-making process comprising the steps of coagulating milk to form curd, cooking the curd to form natural cheese, extruding the natural cheese to form elongated string pieces of said cheese, brining the cheese pieces, and packaging the cheese pieces, the improvement which comprises the step of adding a cheese fortificant during said process at a time selected from the group consisting of before or during said cooking step, during said brining step, and prior to or during said packaging step, and combinations thereof.

11. The process of claim 10, including the step of adding said fortificant before said cooking step.

12. The process of claim 10, said fortificant comprising at least one vitamin.

13. The process of claim 12, said fortificant comprising vitamins selected from the group consisting of Vitamins A, B, B6, C, D, and E, and mixtures thereof.

14. The process of claim 12, said fortificant comprising at least one mineral.

15. The process of claim 14, said mineral selected from the group consisting of copper, iron, zinc, and mixtures thereof.

16. The process of claim 10, said string cheese having a diameter of from about ⅜″-1″.

17. The process of claim 10, including the step of adding a probiotic during the cheese-making process.
